(19) United States
(12) Patent Application Publication
(10) Pub. No.: US 2026/0356481 A1
(43) Pub. Date: Nov. 12, 2026

(54) PIVOTABLE TRAY WITH REDUCED INTERFERENCE

(71) Applicant: B/E Aerospace, Inc., Winston-Salem, NC (US)

(72) Inventors: Brian P. Wenger, Kernersville, NC (US); Tracy N. Pence, King, NC (US); Zane M. Yates, Clemmons, NC (US); John Bracken, Clemmons, NC (US)

(21) Appl. No.: 19/669,635

(22) Filed: May 6, 2026

Related U.S. Application Data
(60) Provisional application No. 63/800,884, filed on May 6, 2025.

(51) Int. Cl. B64D 11/06

(52) U.S. Cl. CPC B64D 11/0638

(57) ABSTRACT

A pivotable tray comprising a tray, at least one pivot point coupled to a base, at least one linkage coupling the tray to the base, and a drive assembly. The drive assembly is adapted and configured to move the tray in a non-radial arc pathway when deploying the tray from a stored configuration to a deployed configuration. In a first embodiment, the drive assembly comprises a cam linkage and a secondary pivot point. In a second embodiment, the drive assembly comprises a driving gear; a pinion; and a rack. In a third embodiment, the drive assembly comprises a load linkage; a drive linkage; a strong pivot point; and a secondary pivot point.

### CROSS-REFERENCE TO RELATED APPLICATIONS

This application claims priority to U.S. Provisional Application No. 63/800,884, filed May 06, 2025, which is hereby incorporated by reference in its entirety.

### TECHNICAL FIELD

The present disclosure relates generally aircraft meal trays and in particular to pivotable meal trays in airplane cabins.

### BACKGROUND

In air travel, passenger comfort must be balanced with the limited space available in the aircraft cabin. In particular, for passengers that are paying for a more luxury experience, there is an increased demand for airlines to provide a more pleasurable flying experience and amenities. However, even in first class or business class seating arrangements, the limited cabin space provides physical limitations that must be accounted for. In particular, trays for meals or for holding entertainment devices are particularly hindered by limited seating areas. Furthermore, simply increasing the tray size is not possible, as trays must be able to transition to a stored configuration. During the transition, the placement of other seats, the aisle, and the cabin wall all act as hinderances to the pathway the tray follows. Trays must be designed to be small enough to transition between the stored and deployed position without interacting with other seats, the cabin wall, or entering into the aisle.

It is therefore desirable to provide systems and methods for trays in aircraft cabins to provide a balance between size to accommodate passenger needs without interference with other seats, the aisle, and the cabin wall.

### SUMMARY

In some aspects, the techniques described herein relate to a pivotable tray including: a tray; at least one pivot point coupled to a base; at least one linkage coupling the tray to the base; and a drive assembly, wherein the drive assembly is configured to move the tray in a non-radial arc pathway when deploying the tray from a stored configuration to a deployed configuration.

In some aspects, the techniques described herein relate to a pivotable tray, wherein the drive assembly includes: a cam linkage; and a secondary pivot point.

In some aspects, the techniques described herein relate to a pivotable tray, wherein the cam linkage includes a first end coupled to the at least one pivot point and a second end coupled to the tray.

In some aspects, the techniques described herein relate to a pivotable tray, wherein at least a portion of the second end of the cam linkage includes a non-linear design adapted for rotating around the secondary pivot point.

In some aspects, the techniques described herein relate to a pivotable tray, wherein the first end of the cam linkage includes an ovular opening adapted for receiving a portion of the at least one pivot point.

In some aspects, the techniques described herein relate to a pivotable tray, wherein translational movement of the cam linkage results in rotational movement of the tray during deploying.

In some aspects, the techniques described herein relate to a pivotable tray, wherein a first end of the at least one linkage is rotatably coupled to the at least one pivot point and a second end of the at least one linkage is rotatably coupled to the tray.

In some aspects, the techniques described herein relate to a pivotable tray, wherein the drive assembly is a slide mechanism.

In some aspects, the techniques described herein relate to a pivotable tray, wherein the slide mechanism includes: a driving gear; a pinion; and a rack.

In some aspects, the techniques described herein relate to a pivotable tray, wherein the rack includes a plurality of teeth.

In some aspects, the techniques described herein relate to a pivotable tray, wherein in response to a pivoting of the tray causes rotation of the driving gear and the pinion, wherein rotation of the pinion results in engagement between the pinion and the plurality of teeth of the rack.

In some aspects, the techniques described herein relate to a pivotable tray, wherein engagement between the pinion and the plurality of teeth results in translational movement of the tray.

In some aspects, the techniques described herein relate to a pivotable tray, wherein the drive assembly includes: a load linkage; a drive linkage; a strong pivot point; and a secondary pivot point.

In some aspects, the techniques described herein relate to a pivotable tray, wherein the strong pivot point is the at least one pivot point coupled to the base.

In some aspects, the techniques described herein relate to a pivotable tray, wherein the drive assembly further includes a rotating disc configured to rotate about the strong pivot point, wherein a first end of the drive linkage is coupled to the rotating disc.

In some aspects, the techniques described herein relate to a pivotable tray, wherein the secondary pivot point includes a pivot base, a rotating member, and one or more engagement members.

In some aspects, the techniques described herein relate to a pivotable tray, wherein the rotating member includes an extending portion adapted for rotatable coupling to the load linkage.

In some aspects, the techniques described herein relate to a pivotable tray, wherein the drive linkage includes a first end coupled to the rotating disc and a second end coupled to the rotating member.

In some aspects, the techniques described herein relate to a pivotable tray, wherein the secondary pivot point includes two engagement members located on opposing ends of the base configured for coupling the tray.

In some aspects, the techniques described herein relate to a pivotable tray, wherein the base is a center console adjacent to a seat, wherein the tray is located on to the center console when in the stored configuration and wherein the tray is located a distance above the seat when in the deployed configuration.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF DRAWINGS

The numerous advantages of the disclosure may be better understood by those skilled in the art by reference to the accompanying figures.

FIG. 1A depicts an isometric, environmental use case of a single pivot tray in a stored configuration according to the prior art;

FIG. 1B depicts a radial arc of travel for a single pivot tray according to the prior art;

FIG. 1C depicts an isometric, environmental use case of a single pivot tray in a deployed configuration according to the prior art;

FIG. 2A depicts an isometric, environmental depiction of a double pivot tray according to embodiments of the present disclosure;

FIG. 2B depicts a perspective view of a double pivot assembly according to embodiments of the present disclosure;

FIG. 2C depicts a first perspective view of the double pivot assembly during deployment according to embodiments of the present disclosure;

FIG. 2D depicts a second perspective view of the double pivot assembly during deployment according to embodiments of the present disclosure;

FIG. 2E depicts an isometric, environmental view of the pathway of travel for a double pivot assembly during deployment according to embodiments of the present disclosure;

FIG. 3 depicts an isometric view of a slide mechanism tray according to embodiments of the present disclosure;

FIG. 4A depicts an isometric view of a four-bar mechanism according to embodiments of the present disclosure;

FIG. 4B depicts a first isometric view of a tray with a four-bar mechanism according to embodiments of the present disclosure; and

FIG. 4C depicts a second isometric view of a four-bar mechanism according to embodiments of the present disclosure.

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

Embodiments of the present disclosure are directed to systems and methods of a pivotable tray that utilizes a non-radial arc pathway when transitioning from a stored configuration to a deployed configuration. As described herein, the present disclosure encompasses several embodiments of a drive assembly that alters the path of travel and/or causes a rotation of the tray in movement, thereby altering the center of rotation for the tray. For example, embodiments of the drive assembly as described herein utilizes at least one translational movement of the tray, thereby altering the path of travel from a circular arc to a non-arc pathway. By way of another example, embodiments of the drive assembly described herein utilize at least one rotation of the tray at a second pivot point, thereby rotating the tray during the primary pivoting of the tray. Utilizing the drive assembly and altering the path of travel, the present disclosure provides for an increase in the size of the tray. In particular, in altering the pathway of travel reduces the effective length of the tray when being deployed, and along with extra space that can be utilized.

As should be understood, while embodiments discussed herein may refer to a meal tray for an aircraft cabin, embodiments of the present disclosure may be deployed in other environments that utilizes the trays or other planar bases that transition from a stored to a deployed configuration. For example, the disclosures provided herein may be utilized in airplane cabins, rail cars, theater or auditorium seating, and/or classroom settings the utilize a pivotable tray, desk, or other planar surface.

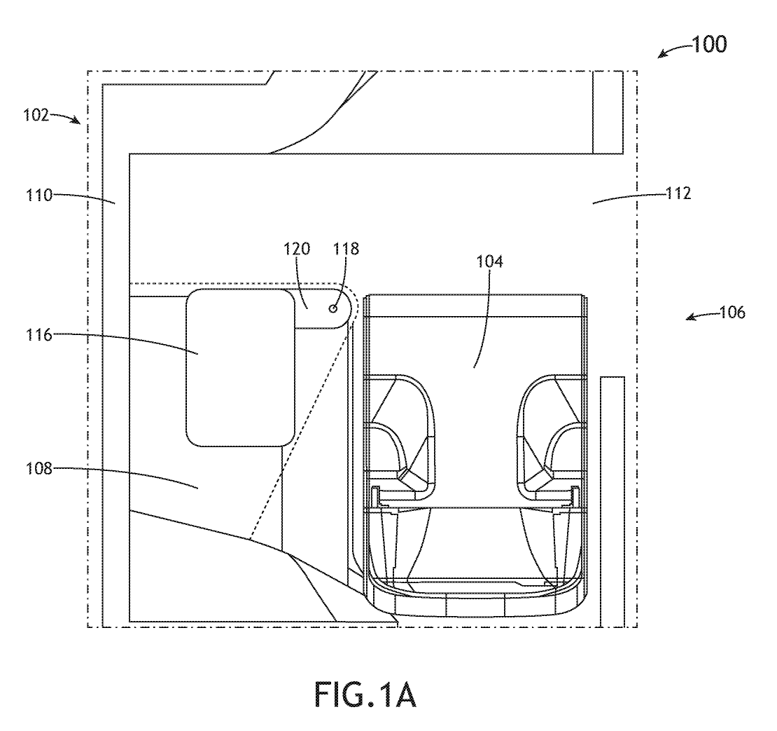

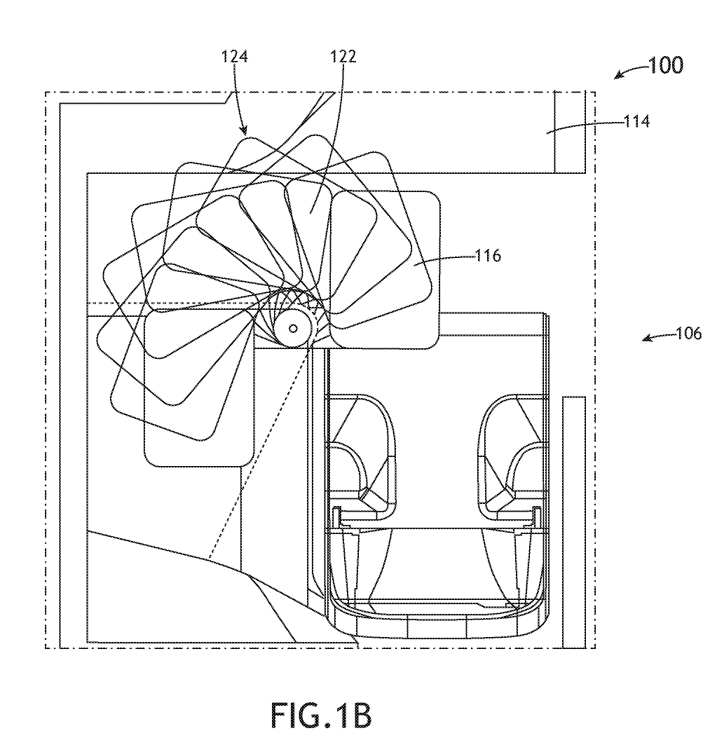

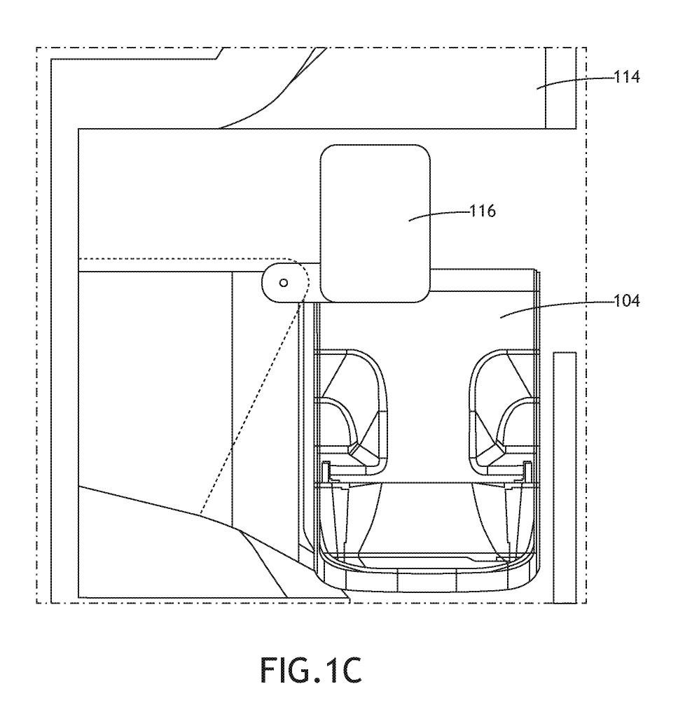

FIGS. 1A-C depicts a single pivot meal tray 100 that is known in the art. As depicted, the single pivot meal tray 100 may be deployed in an airplane cabin 102 comprising a seat 104, an aisle 106, a center console 108 (e.g., a base or other similar structure adjacent to the seat 104), a side partition 110 (e.g., privacy wall or side wall of the airplane cabin 102), leg room area 112, and a front partition 114 (e.g., the back of a forward positioned seat).

As depicted, the single pivot meal tray 100 comprises a tray 116, a pivot point 118, and an arm linkage 120. In embodiments, the tray 116 is a planar piece of material that can be utilized by passengers for holding items, including meals or electronic devices. The tray 116 may be analogous to passenger trays commonly utilized in commercial carriers. For example, the tray 116 may comprise a single, static piece of material or alternatively, may comprise a comprise a dynamic assembly involving a fold out portion The tray 116 may further comprise embossment or formed portions including partitions for food items or a receiving portion for drinks.

In embodiments, the pivot point 118 provides the pivoting hinge of the single pivot meal tray 100. In embodiments, the pivot point 118 is configured to provide both a coupling position for the tray 116 and to provide a base for the tray to pivot about an axis centered on the pivot point 118. For example, the tray 116 and the pivot point 118 via the arm linkage 120, allowing the tray 116 to freely rotate. As further depicted, the pivot point 118 is positioned on the center console 108 and adjacent to the seat 104.

As depicted in FIGS. 1A-C , the tray 116 transitions between a stored configuration (depicted in FIG. 1A) and a deployed configuration (depicted in FIG. 1C). In the stored configuration, the tray 116 may be stored proximate to the center console 108. In the deployed configuration, the tray 116 may be positioned in the leg room area 112 and in a front portion of the seat 104.

As depicted in FIG. 1B, the travel pathway of the tray 116 when paired with a single pivot point 118 is a radial arc pathway 122. When pivoting, the radius of the radial arc pathway 122 depends on the distance between the pivot point 118 and the far end 124 represented by distance L1. As depicted, when the distance L1 between the pivot point 118 and the far end 124 is too long, then during the apex of the radial arc pathway 122, the far end 124 comes in contact with the front partition 114. However, even though the tray 116 comes into contact with the front partition 114 during deployment, there is unused, underutilized space that tray 116 could be utilizing, as depicted. Existing solutions to systems incorporating this single pivot point design include using a smaller meal table or a larger seat pitch to avoid collision between the tray 116 and the front partition 114. However, these solutions are not desirable for a variety of reasons, including economic costs.

Accordingly, a need exists for a deployable tray that combines efficient use of the space between the seat and the different partitions in the seating area. In the embodiments discussed herein, the inventive concepts are directed to pivotable meal trays that travel in non-radial arc pathways. By modifying the path of travel from the radial arc pathway described above, the size of the tray can be increased without risk of the tray coming into contact with the different partitions in the seating area. As described herein, different embodiments of the inventive concepts are disclosed. For example, in a first embodiment, a deployable tray utilizes a double pivot system. In a second embodiment, the deployable tray utilizes a slide mechanism. In a third embodiment, the deployable tray utilizes a four-bar mechanism.

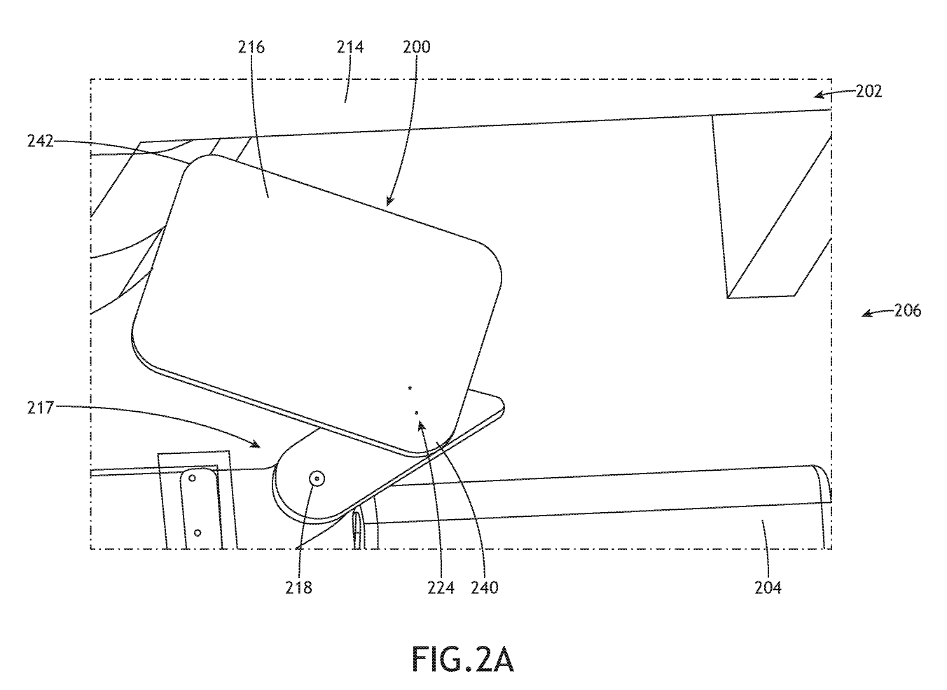

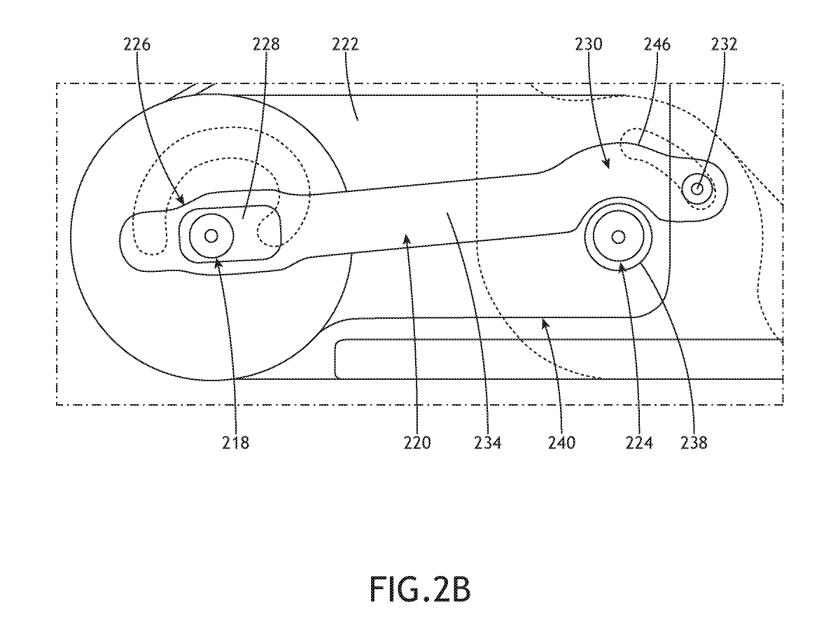

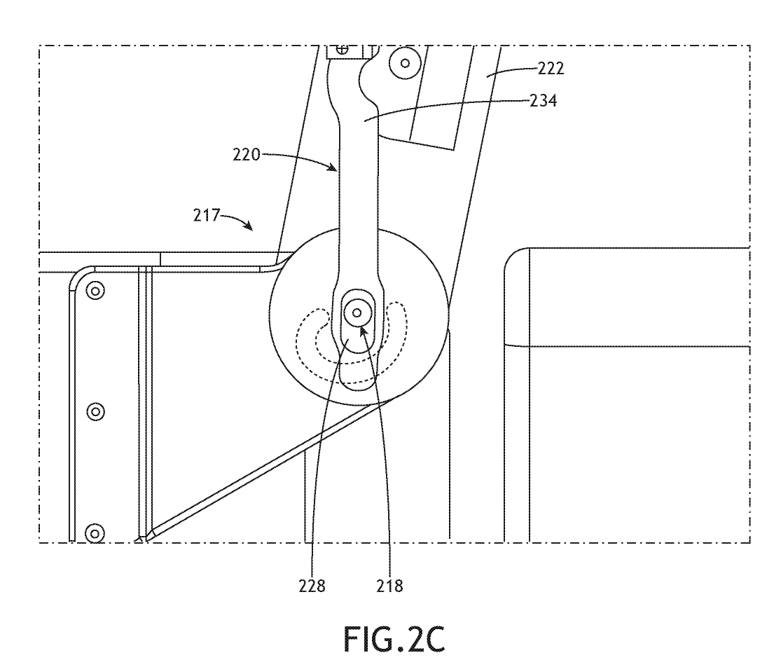

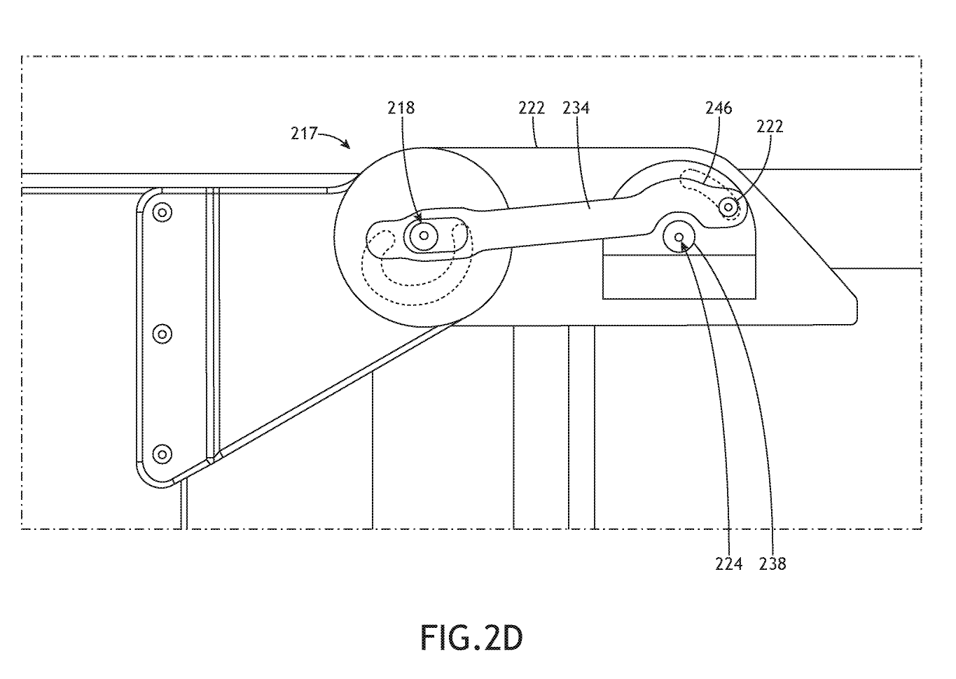

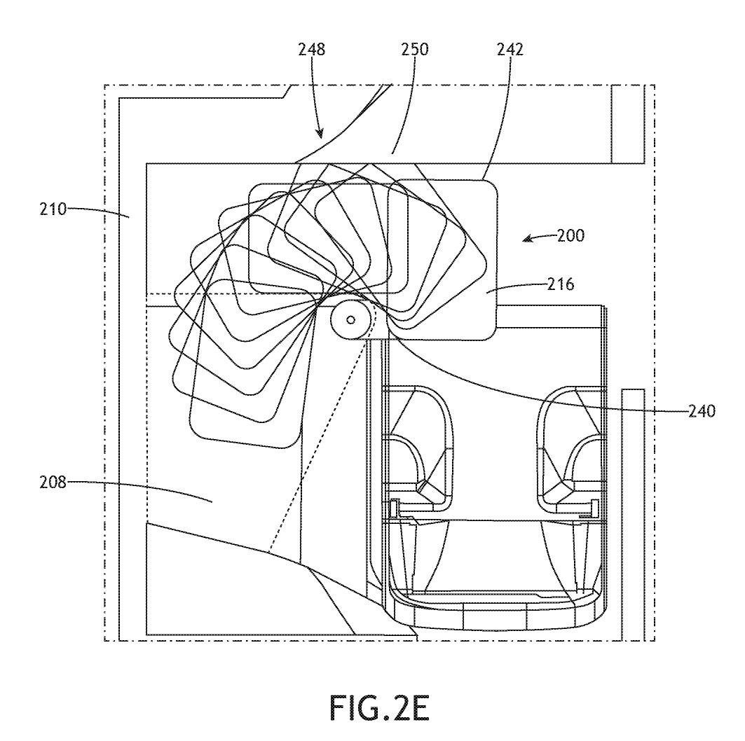

Turning now to FIGS. 2A-E, a first embodiment of a pivotable meal tray is depicted. This first exemplary embodiment is a double pivot meal tray 200 that utilizes a double-pivot drive mechanism (comprising a cam linkage as described below), wherein the pathway of travel from the stored location to the deployed location is a non-radial arc pathway. As depicted, the double pivot meal tray 200 comprises a similar general layout to the prior art single pivot meal tray 100 identified above, including an airplane cabin 202, a seat 204, an aisle 206, a center console 208, a side partition 210, a front partition 214 and a tray 216. In the exemplary embodiment depicted in FIGS. 2A-E, the single pivot meal tray 100 is deployed in a business class or non-economy section of the airplane cabin 202. However, in embodiments, the double pivot meal tray 200 may be deployed in any class section or location in the airplane cabin 102 (or in non-aircraft settings as described above).

In embodiments, the double pivot meal tray 200 comprises a double-pivot assembly 217 comprising a primary pivot point 218, a cam linkage 220, an arm linkage 222, and a secondary pivot point 224. As described herein, the double-pivot assembly 217 is adapted and configured to both pivot the tray 216 for deployment and to also rotate the tray 216, thereby reducing the overall length of the tray 216 and limiting interference with the front partition 214.

As depicted, the primary pivot point 218 may be similar and/or analogous to the pivot point 118 as described above. For example, the primary pivot point 218 may be a coupling point and axis of rotation for the double-pivot assembly 217. As described above, the primary pivot point 218 may be located on the center console 208. In embodiments, the primary pivot point 218 is rotatably coupled to the arm linkage 222, wherein the arm linkage 222 rotates about the primary pivot point 218. In embodiments, when a force is applied to the tray 216, the arm linkage 222 absorbs the load of the force applied to the tray 216 and further remains stiff and maintains its relative position with fixed contact points with the primary pivot point 218 and the tray 216. With respect to the cam linkage 220, when the force is applied, the cam linkage 220 drives the movement and change of position of the tray 216.

In embodiments, the double-pivot assembly 217 further comprises a cam linkage 220. In embodiments, the cam linkage 220 is the mechanical piece providing an oscillating effect to the pathway as the tray 216 transitions from the stored position to the deployed position. As depicted, the cam linkage 220 comprises a first cam end 226 comprising a primary cam opening 228, a second cam end 230 comprising a cam pin 232, and a cam linkage body 234 disposed between the first cam end 226 and the second cam end 230. In embodiments, the cam linkage body 234 is a length of material disposed between the first cam end 226 and the second cam end 230.

In embodiments, the primary cam opening 228 is adapted and/or configured for coupling to the primary pivot point 218. Furthermore, the coupling between the primary cam opening 228 and the primary pivot point 218 is further adapted and figured as a rotatable coupling, providing for the cam linkage 220 to rotate about the primary pivot point 218. Even further, the primary cam opening 228 may comprise an ovular shape and may further be sized to provide some play between the cam linkage 220 and the primary pivot point 218. In this regard, during the pivoting of the tray 216 during deployment, some linear movement of the cam linkage 220 occurs, providing the oscillating effect of the cam profile. Accordingly, because of the oscillating effect, the pathway of travel comprises a non-radial arc profile, as depicted in FIG. 2B. during movement to have an oscillated effect, providing for the non-radial arc pathway of travel.

As further depicted, the second cam end 230 of the cam linkage 220 comprises a non-linear design, adapted to at least partially surround and rotate about the secondary pivot point 224. For example, at least a portion of the second cam end 230 comprises a radial design corresponding to a circular design of the secondary pivot point 224. Furthermore, the distal end of the second cam end 230 further comprises a cam pin 232 or engaging member for engaging with the primary cam opening 228 located in the tray 216. For example, during deployment, the cam pin 232 engages with the tray 216 for driving movement of the tray 216 from the stored to deployed position, and vice versa. In embodiments, the cam pin 232 comprises a bulbous end or other configuration for retaining its position when located in the opening located in the tray 216.

As further depicted, the tray 216 is adapted and/or configured with engagement with both the arm linkage 222 and the cam linkage 220. For example, the tray 216 comprises a first coupling point 238 for engaging with the secondary pivot point 224. In embodiments, the first coupling point 238 may be positioned relative to an interior corner 240. As depicted, the interior corner 240 is located opposite from the apex corner 242 (i.e., the corner that corresponds to the apex in the pathway of travel of the tray 216). As described herein, the tray 216 rotates about the secondary pivot point 224, providing an oscillating effect to the tray 216 when deploying. In embodiments, the first coupling point 238 is an opening defined into the body of tray 216 adapted for rotatable coupling with secondary pivot point 224. For example, a pin may be utilized in insertion into the first coupling point 238 and the secondary pivot point 224 for retaining the coupling.

As further depicted, the tray 216 further comprises a secondary opening 246 for engaging with the cam linkage 220. In embodiments, the secondary opening 246 is located adjacent to the first coupling point 238 and located in an interior position relative to the center of the tray 116. In embodiments, the secondary opening 246 comprises an oblong opening that the cam pin 232 can both rest in and transverse through during movement. As described herein, the pathway of travel is a non-radial pathway. Accordingly, the secondary opening 246 comprises a non-circular or ovalular shape. In this manner, the cam pin 232 engages in a non-linear, translational movement while moving in the secondary opening 246.

Accordingly, in embodiments, the location of the secondary pivot point 224 being located at an interior position and being linked to the primary pivot point 218 via the cam linkage 220 results in a dynamic, variable center of rotation for the secondary pivot point 224. Furthermore, in the described configuration, the rotational position of the secondary pivot point 224 during travel is controlled as a function of the rotational position of the primary pivot point 218.

Turning now to FIGS. 2C-E, an exemplary path of travel of the tray 216 is depicted. FIGS. 2C-D depicts the movement of the double-pivot assembly 217 when the tray 216 is in motion. FIG. 2E depicts the non-radial arc pathway of travel of the tray 216. In the stored position, the tray 216 may be stored approximate to the center console 208. For example, the center console 208 may have a recessed region adapted for receiving the tray 216 while in the stored configuration. Furthermore, while the illustrated embodiment depicts the tray 216 stored in a vertical position relative to the center console 208, in some embodiments, the tray 216 may be initially stored in a horizontal position, such as adjacent to 104. Furthermore, in such embodiments, the tray 216 may comprise at least one vertical movement prior to rotation in the horizontal plane.

In embodiments, when the tray 116 is in the stored configuration, the positioning of the cam linkage 220 can be in a first position. For example, in the stored configuration, the primary pivot point 218 can be engaged and rested with the primary cam opening 228 at a first position, with the cam pin 232 also engaged and rested in the secondary opening 246 of the tray 116. As depicted in FIGS. 2C-E, as the tray 216 travels along pathway 248, the positioning of the primary pivot point 218 within primary cam opening 228 and the positioning of the cam pin 232 in the secondary opening 246 changes depending on the current position of the tray 216 on pathway 248. For example, FIG. 2E depicts the tray 216 relative to the apex 250 of pathway 248. As can be seen, the primary pivot point 218 is engaged relative to the interior part of the primary cam opening 228. Accordingly, when engaged in such a position, the location of the apex 250 is brought inward, towards the seat 204, thereby reducing the overall length of the pathway 248 and limiting interference with the front partition 214.

Furthermore, as the tray 216 continues along pathway 248, the driving force results in translational movement of the cam linkage 220 about the primary pivot point 218 and the secondary pivot point 224. For example, as depicted in FIGS. 2C-E , as the tray 216 is moved past the apex 250, the position of the primary pivot point 218 and the cam pin 232 within the primary cam opening 228 and secondary opening 246 moves accordingly. When the tray 216 has reach the deployed position and is at the end of pathway 248, the primary pivot point 218 can be engaged and rested with the primary cam opening 228 at a second position (i.e., the opposite end of the primary cam opening 228), with the cam pin 232 also engaged and rested in the secondary opening 246 of the tray 116 at a second position (i.e., the opposite end of the secondary opening 246).

Through the translational movement of the cam linkage 220, the tray 216 follows a non-radial arc shape when traveling along pathway 248. An exemplary depiction of a non-radial arch pathway is depicted in FIG. 2E. For example, prior to the tray 216 moving in a radial movement, an initial movement of tray 216 involves a linear movement along the x-axis, or towards the seat 204. Accordingly, through such movement, the location of the apex 250 is reduced, allowing for an increase in the size of tray 216 without interference with other objects during transition from the stored to deployed configuration. For example, a tray 216 comprising a double pivot drive mechanism can decrease the location of the apex 250 by approximately 2 inches, resulting in a potential total surface area increase of tray 216 by approximately 30 inches.

As described herein, inventive concepts are directed to a pivotable meal tray that follows a non-radial arc pathway when deployed from a stored configuration to a deployed configuration. While the above-described embodiment as directed to a pivotable meal tray comprising a double pivot mechanism incorporating the use of a cam linkage, the present disclosure may utilize alternative designs that result in the same, or similar, effect of a non-radial arc pathway of travel for the tray.

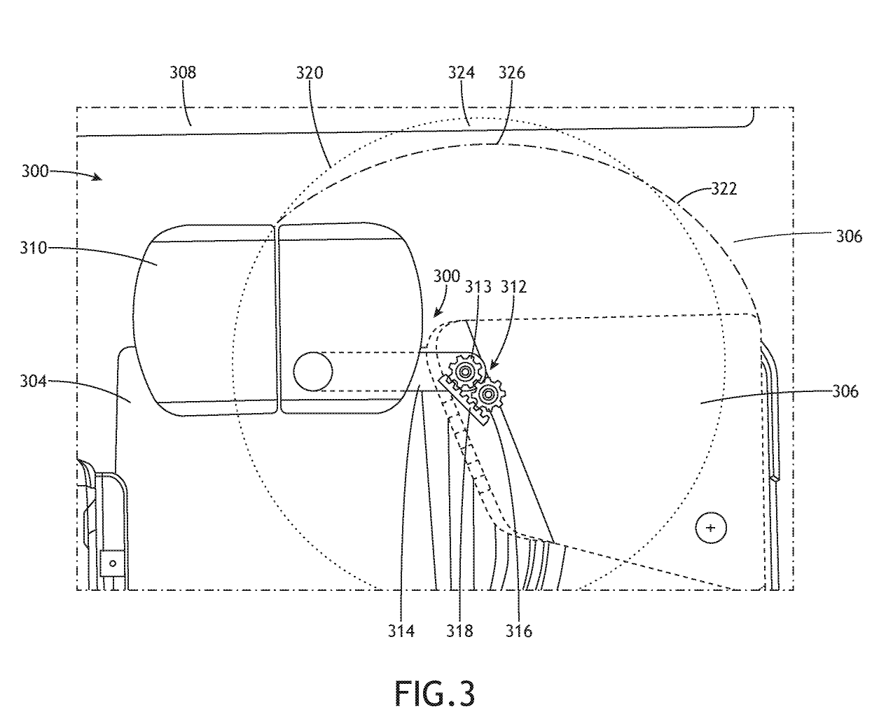

For example, an alternative embodiment of a slide mechanism tray 300 is depicted in FIG. 3. As depicted in FIG. 3, the slide mechanism tray 300 may comprise the same basic layout of other embodiments as described herein, including an airplane cabin 302, a seat 304, a center console 306, a front partition 308, and a tray 310. In embodiments, the drive mechanism for providing the non-radial arc pathway of travel when deploying the tray 310 is a slide mechanism 312, comprising an arm linkage 314, a driving gear 313, a pinion 316, and a rack 318.

In embodiments, the rack 318 is a length of material comprising a plurality of teeth for the pinion 316 to engage with. During rotation of the tray 310, the engagement between the rack 318 and the pinion 316 results in a conversion between rotational motion and linear motion (i.e., rotating the pinion 316 causes the rack 318 to be driven in a line and conversely, moving the rack linearly will cause the pinion 316 to rotate), with linear movement of the tray 310 occur during deployment.

In embodiments, the slide mechanism 312 is coupled to a first end of the arm linkage 314 and to the center console 306. For example, the driving gear 313 and the pinion 316 may be located in a housing that may be located on center console 306, with a portion of the rack 318 coupled to the arm linkage 314. Through the coupling between the tray 310 (via arm linkage 314) and the slide mechanism 312, the positioning of the tray 310 during transition between the stored and deployed configuration can be controlled.

For example, as depicted in FIG. 3, an original, radial arc pathway 320 of travel is depicted, representative of a tray utilizing a single pivot mechanism. As demonstrated, when the tray 310 comprises dimensions past a certain threshold, the radial arc pathway 320 results in a collision between the tray 310 and the front partition 308 at a first apex 324. FIG. 3 further depicts a non-radial arc pathway 322 corresponding to an embodiment of tray 310 adapted with the slide mechanism 312. As depicted, the slide mechanism 312 results in a flatter pattern of travel, with a second apex point 326 being moved a distance away from the front partition 308, thereby avoiding a collision between the tray 310 with the front partition 308.

In embodiments, the non-radial arc pathway 322 occurs as a result of the of the linear movement of the rack 318 in response to the rotational movement of the pinion 316. For example, as the tray 310 is pivoted, the rotation of the tray 310 may be centered on the fixed position of the driving gear 313, thereby causing rotation of the driving gear 313. The rotation of the driving gear 313 further causes rotational movement of the pinion 316, which in turn engages with the rack 318. The positioning of the rack 318 is adapted so that when the tray 310 is located at the second apex point 326, the rack 318 is at its shortest effective length, thereby moving the second apex point 326 away from the front partition 308. Accordingly, through such reduction, the non-radial arc pathway 322 avoids interference with the front partition 308.

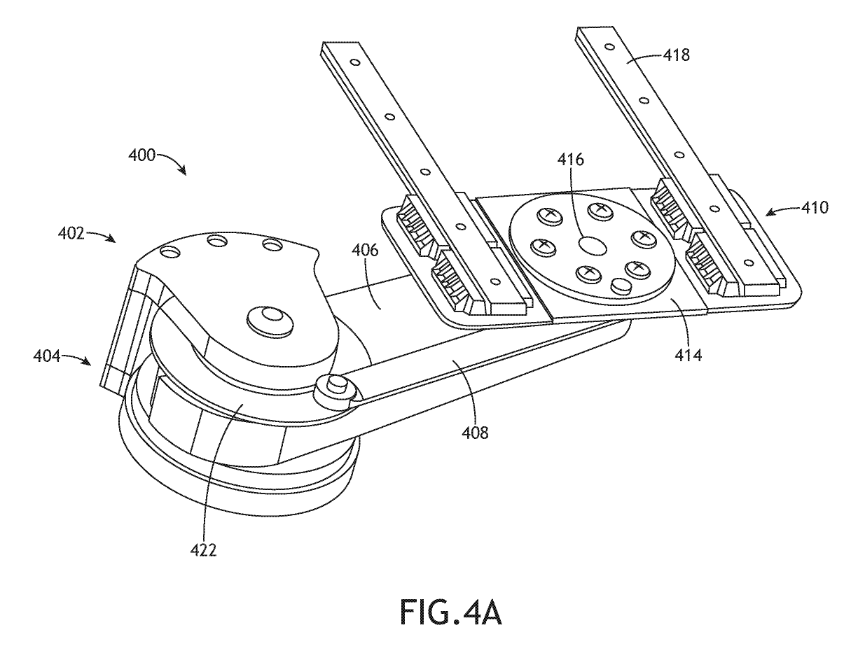

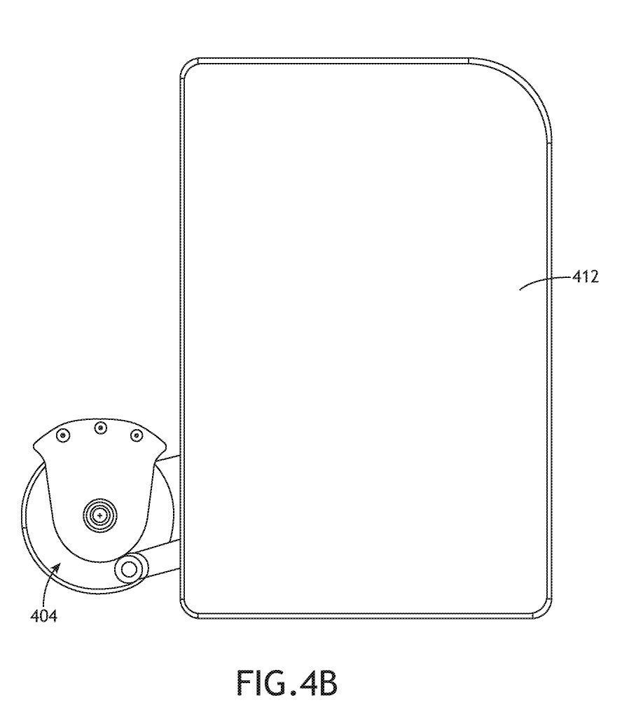

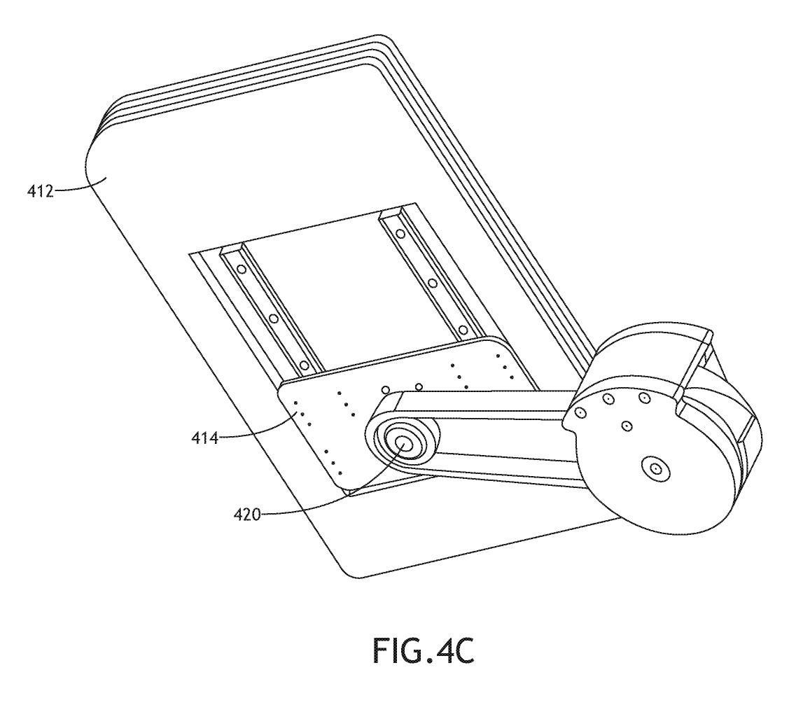

FIGS. 4A-C depict an exemplary third embodiment of a pivotable tray adapted with a drive mechanism resulting in a non-radial arc pathway. Specifically, FIGS. 4A-C depict an embodiment of a pivotable tray with a four-bar mechanism 400. While not depicted in FIGS. 4A-C , the pivotable tray with a four-bar mechanism 400 can be deployed in the environments described above, including for example an airplane cabin environment comprising a seat, an aisle, a center console, a side partition, leg room area, a front partition, and a tray.

In embodiments, the pivotable tray with a four-bar mechanism 400 comprises a four-bar drive system 402 including a strong pivot point 404, a load link 406, a drive link 408, and secondary pivot point 410. Furthermore, the four-bar drive system 402 is coupled to a tray 412, similar to the embodiments described above. As described herein, the four-bar drive system 402 is adapted to provide a rotational/oscillating effect during the pivoting of the tray 412, thereby causing a non-radial arc pathway of travel.

In embodiments, the strong pivot point 404 acts as the central base of the four-bar drive system 402 when pivoting the tray 412. In embodiments, the strong pivot point 404 is coupled to a center console or other position relative to a seat for which the pivotable tray with a four-bar mechanism 400 is deployed with. Furthermore, the strong pivot point 404 is adapted and configured as a rotational pivot point, acting as the rotational base of the load link 406 and the drive link 408.

In embodiments, the secondary pivot point 410 provides the rotational effect to the tray 412 during pivoting/deployment from the stored configuration to the deployed configuration. As depicted, the secondary pivot point 410 comprises a four-bar base 414, a rotating disc 416, and one or more tray engagement members 418. As depicted, the four-bar base 414 may act as a central coupling point for the rotating disc 416 and the one or more tray engagement members 418. For example, the four-bar base 414 may be a planar, or rectangular piece of material. As further depicted, the rotating disc 416 may be a pivotable, rotatable disc centered within four-bar base 414. The rotating disc 416 may further comprise an extension member 420 which, as described below, may be used to rotatably couple the secondary pivot point to the load link 406. The rotating disc 416 may further comprise one or more openings for receiving a pin or other engagement member of the drive link 408, thereby coupling the drive link 408 and the secondary pivot point together. As further depicted, the one or more tray engagement member 418 may be coupled to or formed from four-bar base 414. In embodiments, the one or more tray engagement members 418 may be lengths of material adapted for receiving one or more fasteners to couple with the tray 412. In the exemplary embodiment, the secondary pivot point 410 comprises two tray engagement members 418 disposes on opposing sides of the four-bar base 414. As further depicted in FIG. 4B, the tray 412 may comprise a recessed region corresponding to the relative size and dimension of the tray engagement members 418, whereby the one or more tray engagement members 418 may be placed within the recessed region and secured to tray 412 using one or more fasteners. In embodiments, the one or more tray engagement members 418 are further adapted for receiving at least a portion of the load during pivoting/rotation of the tray 412.

In embodiments, the load link 406 is a linkage adapted and configured to couple to the strong pivot point 404 at a first position and to the secondary pivot point 410 at a second position. Furthermore, in embodiments, the load link 406 is rotatably coupled to each of strong pivot point 404 and the secondary pivot point 410. For example, as the tray 412 is pivoted, the movement of the tray 412 results in rotational movement of the load link 406, with the rotation being centered about the strong pivot point 404. As described below, the pivoting of the tray 412 further results in rotational movement via the four-bar drive system 402. As such, during pivoting, the tray 412 may rotate about the secondary pivot point 410, with the load link 406 absorbing the force of the load. Accordingly, the load link 406 may be configured with dimensions and/or constructed from a material sufficient to handle the load of the applied force. In embodiments, the coupling between the load link 406 and the secondary pivot point 410 may be achieved through an opening defined at the second position of the load link 406, adapted for receiving the extension member 420. Upon insertion of the extension member 420, the secondary pivot point 410 may rotate about the load link 406.

In embodiments, the drive link 408 is a link in the four-bar drive system 402 that is adapted and configured to drive the oscillating/rotational movement of the tray 412 when the tray 412 is being moved from a stored configuration to a deployed configuration. As depicted, the drive link 408 is rotatably coupled to each of the strong pivot point 404 at a first position and to the secondary pivot point 410 at a second position. In embodiments, the drive link 408 couples to the strong pivot point 404 at a rotational base 422. The rotational base 422 may be a disc or other circular piece of material adapted for rotation around the strong pivot point 404. Accordingly, when the tray 412 is pivoted, the drive link 408 can therefore rotate relative to the strong pivot point 404 via the coupling with the rotational base 422.

As further depicted, the drive link 408 couples to the secondary pivot point 410 via a coupling between the drive link 408 and the rotating disc 416. In embodiments, the rotating disc 416 further comprises one or more openings adapted for receiving a pin or extending member from the drive link. As depicted, the drive link 408 comprises a pin located at a distal end, opposite from the end coupling to the rotational base 422. The pin may be inserted and retained within the opening of the rotating disc 416.

In embodiments, the four-bar drive system 402 may comprise a two-stage pivot when deploying the tray 412. For example, in a first stage of rotation, a simple rotation centered about the strong pivot point 404 may occur. During this initial rotation, a 90-degree rotation of the tray 412 occurs.

In embodiment, during the second stage of rotation, the four-bar drive system 402 undergo a second rotation driven by the four-bar drive system 402. For example, after the initial stage of rotation, the drive link 408 undergoes a translational movement, which results in rotational movement of the secondary pivot point 410 and by extension, the tray 412. As a result of the rotational movement of the secondary pivot point 410, the tray 412 is reciprocally rotated towards the strong pivot point 404, resulting in a change of the center of rotation of the tray 412. Similar to the embodiment described above with respect to FIGS. 2A-E, the rotation of the tray 412 towards the strong pivot point 404 results in a non-radial arc pathway of travel and a shortening of the overall length of the tray 412 when deploying.

The described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively "associated" such that the desired functionality is achieved. Hence, any two components herein combined to achieve a particular functionality can be seen as "associated with" each other such that the desired functionality is achieved, irrespective of architectures or intermedial components. Likewise, any two components so associated can also be viewed as being "connected" or "coupled" to each other to achieve the desired functionality, and any two components capable of being so associated can also be viewed as being "couplable" to each other to achieve the desired functionality. Specific examples of couplable include but are not limited to physically interactable and/or physically interacting components and/or wirelessly interactable and/or wirelessly interacting components and/or logically interactable and/or logically interacting components.

It is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. A pivotable tray comprising:
a tray;
at least one pivot point coupled to a base;
at least one linkage coupling the tray to the base; and
a drive assembly,
wherein the drive assembly is configured to move the tray in a non-radial arc pathway when deploying the tray from a stored configuration to a deployed configuration.

2. The pivotable tray of claim 1, wherein the drive assembly comprises:
a cam linkage; and
a secondary pivot point.

3. The pivotable tray of claim 2, wherein the cam linkage comprises a first end coupled to the at least one pivot point and a second end coupled to the tray.

4. The pivotable tray of claim 3, wherein at least a portion of the second end of the cam linkage comprises a non-linear design adapted for rotating around the secondary pivot point.

5. The pivotable tray of claim 4, wherein the first end of the cam linkage comprises an ovular opening adapted for receiving a portion of the at least one pivot point.

6. The pivotable tray of claim 5, wherein translational movement of the cam linkage results in rotational movement of the tray during deploying.

7. The pivotable tray of claim 1, wherein a first end of the at least one linkage is rotatably coupled to the at least one pivot point and a second end of the at least one linkage is rotatably coupled to the tray.

8. The pivotable tray of claim 7, wherein the drive assembly is a slide mechanism.

9. The pivotable tray of claim 8, wherein the slide mechanism comprises:
a driving gear;
a pinion; and
a rack.

10. The pivotable tray of claim 9, wherein the rack comprises a plurality of teeth.

11. The pivotable tray of claim 10, wherein in response to a pivoting of the tray causes rotation of the driving gear and the pinion, wherein rotation of the pinion results in engagement between the pinion and the plurality of teeth of the rack.

12. The pivotable tray of claim 11, wherein engagement between the pinion and the plurality of teeth results in translational movement of the tray.

13. The pivotable tray of claim 1, wherein the drive assembly comprises:
a load linkage;
a drive linkage;
a strong pivot point; and
a secondary pivot point.

14. The pivotable tray of claim 13, wherein the strong pivot point is the at least one pivot point coupled to the base.

15. The pivotable tray of claim 14, wherein the drive assembly further comprises a rotating disc configured to rotate about the strong pivot point, wherein a first end of the drive linkage is coupled to the rotating disc.

16. The pivotable tray of claim 15, wherein the secondary pivot point comprises a pivot base, a rotating member, and one or more engagement members.

17. The pivotable tray of claim 16, wherein the rotating member includes an extending portion adapted for rotatable coupling to the load linkage.

18. The pivotable tray of claim 17, wherein the drive linkage comprises a first end coupled to the rotating disc and a second end coupled to the rotating member.

19. The pivotable tray of claim 18, wherein the secondary pivot point comprises two engagement members located on opposing ends of the base configured for coupling the tray.

20. The pivotable tray of claim 1, wherein the base is a center console adjacent to a seat, wherein the tray is located on to the center console when in the stored configuration and wherein the tray is located a distance above the seat when in the deployed configuration.
